(19) United States
(12) Patent Application Publication
(10) Pub. No.: US 2013/0149958 A1
(43) Pub. Date: Jun. 13, 2013

(54) LAN BASED SATELLITE ANTENNA/SATELLITE MULTISWITCH

(71) Applicant: The DIRECTV Group, Inc., Ei Segundo, CA (US)

(72) Inventors: Robert Davis, Woodbine, MD (US); Michael Ficco, Silver Spring, MD (US); Peter Pardee, Ramona, CA (US)

(73) Assignee: The DIRECTV Group, Inc., Ei Segundo, CA (US)

(21) Appl. No.: 13/766,575

(22) Filed: Feb. 13, 2013

Related U.S. Application Data
(63) Continuation of application No. 10/123,383, filed on Apr. 15, 2002, now abandoned.
(60) Provisional application No. 60/284,593, filed on Apr. 18, 2001.

(51) Int. Cl. H04W 16/00

(52) U.S. Cl. CPC H04W 16/00
USPC 455/12.1

(57) ABSTRACT

A satellite communication system including an interface device for distributing satellite signals received from an outdoor unit (ODU) to a plurality of indoor units (IDUs) connected to a local area network (LAN), at a particular site. Only two cables, a power cable and a cable connected to the LAN, must be installed between the interface device and the site containing the IDUs. Accordingly, the installation of IDUs at a site is simplified and has the flexibility of allowing future satellite based services to be added without requiring the installation of new cables between the ODU and the IDUs. The satellite communication system also permits flexibility among connected devices, including to which other devices they are connected, how they are connected to other devices and what types of connections are used.

### BACKGROUND OF THE INVENTION

1. Field of the Invention

This invention relates generally to the connection of a satellite antenna to multiple indoor units (IDUs), and more specifically, to an interface which connects at least one satellite antenna to multiple indoor units by means of a local area network (LAN).

2. Description of the Related Art

Satellite antennas generally comprise a parabolic dish preferably constructed of metal, which reflects and focuses the incoming signals toward a feedhorn. The feedhorn is a device that is positioned in front (usually supported by an arm structure) for gathering the focused signal and sending it to a Low Noise Block converter (LNB). The LNB converts a whole band, or block, of frequencies received from the feedhorn into a lower band, while also providing electronic amplification of the received signal. Together, the satellite antenna, feedhorn, and LNB may comprise what is called an outdoor unit (ODU).

Coaxial cables connect the LNB of the ODU at the satellite antenna to an indoor unit (IDU), which is a unit that may comprise a receiver or a transceiver allowing a user to receive and/or transmit data over the satellite network. One or more of the cables connecting the IDU to the LNB is used to supply the LNB with power, while data, is communicated between the LNB and the IDU through one or more other cables.

As satellite based services continue to evolve, the number of cables required for communicating data between the LNB and the IDU will increase. Already, satellite services, which include digital television subscription services such as DIRECTV®, can require multiple cables between the ODD and the IDU. For example, subscribers who also want to view local stations may be required to connect an analog antenna to the ODU for receiving analog radio or television signals (which should be captured and digitized prior to further processing). In this case, even more cables are required for connecting the LNB and the antenna outputs, respectively, to the receiver and local antenna feed of the subscriber's television.

Other satellite based services are currently offered which use different cables for different satellites, different polarities, and different functions (for example, both a data transmit and data receive cable) to connect the ODD and the IDU. Additional services may further require multiple transmit and receive cables. Services currently envisioned for the near future may require up to five or ten cables.

It is a common practice to use a multiswitch in a satellite communication system to connect multiple LNB outputs to one or more IDUs. Such LNB outputs may originate from the same satellite antenna (e.g., from a dual LNB), or from multiple proximate antennas that receive/transmit satellite signals for IDUs at a common location (the term ODU may be used to represent such multi-antenna configurations as well as single antenna configurations). A multiswitch can either be located at, or mounted at a location remote from, the ODU. A separate cable is used for connecting each LNB output to the multiswitch, and a separate cable is output from the multiswitch to each IDU. The multiswitch is responsible for connecting the correct LNB to each IDU, as commanded by the IDU. Further, the multiswitch can be used to split a LNB output among two different IDUs.

For example, a multiswitch can be used to allow multiple people living in a residential building (e.g., house or apartment building) to watch different satellite television channels at the same time using a single satellite antenna. In such a configuration, a dual band signal is received by a dual LNB (or by two separate LNBs mounted on the antenna), and each LNB output is connected to the multiswitch, which splits the satellite signal among a plurality of receivers in the building. Assuming that there are four people living in the building each requiring a separate receiver, a total of at least five cables must be installed between the multiswitch and the building. This includes the four cables connecting the multiswitch to each receiver, as well as a power cable connecting the multiswitch to a power source (e.g., wall outlet) within the building.

For the conventional satellite communication system described above, the addition of new services after the initial installation of the system can be quite inconvenient. Each new service may require one or more additional cables to be connected between the ODU (either directly from an LNB or from a multiswitch) and the IDU corresponding to the new service. With respect to the example discussed above, if a person living in the building wanted to receive satellite based Internet service (e.g., DIRECPC® or any other information, such as streaming audio and/or video or voice over IP) to his/her home, a new cable must be installed between the multiswitch and a new receiver connected to the person's personal computer (PC). The installation of such cables in a building can be quite complex, expensive and time consuming.

Further, conventional satellite systems can be quite inflexible. The number of IDUs that can be connected to a multiswitch is limited. When all of the outputs of the multiswitch are occupied, the addition of new services and/or new IDUs would necessitate a reconfiguration of the ODU. Also, current multiswitches are only able to feed each output of a dual LNB into a limited number of receivers. For instance, many of the available multiswitches can distribute a dual LNB output to two different receivers, resulting in a limit of four receivers being connectable to each dual LNB. To allow for more receivers, one would be required to install at least one additional LNB or multiswitch.

It would be advantageous to simplify the installation of multiple IDUs at a particular site, while reducing the number of cables required for such an installation. It would also be advantageous to substantially increase the number of IDUs that can access a single ODU. Further, it would be advantageous to allow for new IDUs and/or new services to be installed at a particular site without needing to install more cables.

### SUMMARY OF THE INVENTION

The present invention provides an interface that connects the plurality of LNB outputs to a local area network (LAN), which is connected to each IDU at a particular site. In particular, for each LNB at the ODU side, the interface of the present invention includes a receiver that converts the radio frequency (RF) signal from the LNB output into digital baseband information. This digital baseband information from each LNB output can be filtered, compressed and encrypted by the interface before being multiplexed together and sent by means of the LAM to the corresponding IDUs. The data can be sent to directly to its intended IDU using point-to-point communications, or alternatively, can be broadcast to each IDU.

A first aspect of the present invention embodies an apparatus acting as an interface between a satellite antenna and a plurality of IDUs in a satellite communication system. This interface device includes a cable connection to each LNB output of the antenna, similar to a conventional multiswitch. Unlike a multiswitch, however, the interface device requires at most two additional cables, regardless of the number of IDUs in the system. One of these cables connects the interface device to a power source, while the other cable is a connection to a wired LAN, which is further connected to all of the IDUs. In this aspect, the interface device may include a processor that runs a set of protocols for controlling the transmission of data over the network. Further, the interface device may be built into the satellite antenna, or alternatively, may be configured as a standalone device within or outside of a building housing the IDUs.

A second aspect of the present invention is directed to an apparatus acting as an interface between a satellite antenna and a plurality of IDUs, which requires only cable connections to each LNB output and the power source. In this aspect, the interface device and IDUs are connected together through a wireless LAN. Accordingly, the interface device includes an RF transmitter/receiver to transmit to and receive data from the wireless LAN. Each IDU also includes either an RF transmitter/receiver, or an RF receiver, depending upon whether or not the IDU is operative to transmit data via the satellite network. Similar to the first embodiment the interface device also includes a processor that runs a set of protocols for controlling the transmission of data over the network.

A third aspect of the present invention is directed to a device acting as an interface between the satellite antenna and a plurality of IDUs, similar to either the first and second aspects, the only difference being that the interface device, or other device connected to the LAN, runs a server application that stores data received by the satellite antenna. Accordingly, an IDU can access the server application via the LAN and download the stored data.

This aspect of the present invention is particularly well suited for the delivery of video or other types of data, on demand. For example, a satellite antenna and interface device according to this aspect can be implemented on an airplane to receive content such as movie, music, etc. from a content provider over a satellite network. The content can be stored in a server inside the airplane and available over an LAN. In this example, a passenger can plug a laptop computer into a jack near his/her seat, and be able to download and play movies or music for a fee. The present invention can provide similar services in a cruise boat, train, or any location, which includes many potential customers and which, cannot feasibly communicate to content providers over physical communication lines.

A fourth aspect of the present invention is directed to the relationship between satellites and outdoor units (ODUs). For example, each satellite may transmit to a specific ODU or more than one satellite may transmit to the same ODU. In a similar manner, one or more satellites could transmit to the same ODU. An ODU which is led by multiple satellites may be considered a “super” ODU.

A fifth aspect of the present invention is directed to using the interface and/or the LAN as a converter. Although the original signal received by the ODU is a particular type of signal, the LAN or the interface may supply the information to IDUs via a different connectivity. This different connectivity may include internet connections (either wired or wireless), DSL, cable modem, T1, phone line (either phone LAN, DSL, or cable), power line or other type of connection.

A sixth aspect of the present invention is directed to the use of a gateway, which permits the IDU to transmit to devices and/or LAN over any type of connection. As described above, these connection could be any of the previous types of connections.

A seventh aspect of the present invention is directed to the use of the interface acts as an converter and/or concentrator. The interface may receive information from any number of connections, such as DSL, satellite, cable, among others. The interface may also receive information from other wide area products and from other devices such as CD players. The interface may convert and/or concentrate the received information for forwarding to the LAN 50. The interface may also include outgoing connections for sending control/request information to any of the information sources.

An eighth aspect of the present invention is directed to chaining together one or more IDUs 32 such that the throughput of one or more IDUs may be combined together and dynamically allocated to produce one or more output streams, larger than that which could be produced by any one IDU alone. The larger output stream may be supplied to any number of devices which require extra throughput.

Advantages of the present invention will become more apparent from the detailed description given hereafter. However, it should be understood that the detailed description and specific examples, while indicating preferred embodiments of the invention, are given by way of illustration only, since various changes and modification within the spirit and scope of the invention will become apparent to those skilled in the art from this detailed description.

### BRIEF DESCRIPTION OF THE DRAWINGS

The features and advantages of the invention will be more readily understood from the detailed description given below and the accompanying drawings, which are given for the purposes of illustration only, and thus do not limit the present invention.

FIG. 1 illustrates a typical satellite communication system in which the apparatus of the present invention can be used.

FIG. 2 illustrates an exemplary embodiment of the present invention, which includes an interface device connecting the LNBs of an ODU to multiple IDUs using a wired LAN.

FIG. 3 illustrates an exemplary embodiment of the present invention where an interface device connects the LNBs of an ODU to multiple IDUs using a wireless LAN.

FIG. 4 illustrates an exemplary embodiment in which the present invention includes a server application to store and provide content on demand to a plurality of IDUs.

FIG. 5 is a block diagram of the interface device according to an exemplary embodiment of the present invention.

FIGS. 6 and 7 illustrate exemplary embodiments of various relationships between satellites and ODUs.

FIG. 8 illustrates an exemplary embodiment in which one or more elements of the present invention act as a data converter.

FIG. 10 illustrates an exemplary embodiment in which one or more elements of the present invention is utilized as a converter and/or concentrator.

FIG. 11 illustrates an exemplary embodiment in which the output of a plurality of elements of the present invention are aggregated and dynamically allocatable.

### DETAILED DESCRIPTION OF EXEMPLARY EMBODIMENTS

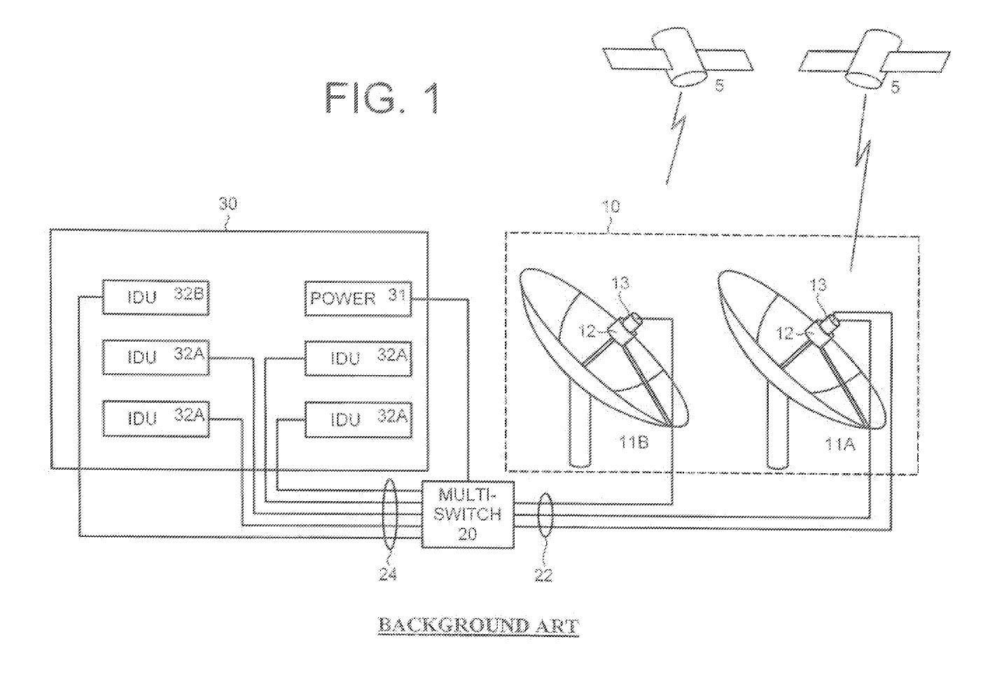

Referring to the drawings, FIG. 1 illustrates a typical satellite communication system in which the apparatus of the present invention can be used. FIG. 1 shows an ODU 10 including satellite antennas 11A and 11B for receiving signals transmitted by satellites 5. Each of antennas 11A, 11B is comprised of a dish (preferably, metal), which focuses the received signal to feedhorn 12. After collecting the focused signal, the feedhorn 12 directs the signal to one or more LNBs 13. The LNBs 13 of antennas 11A and 11B amplify and send the signal via cables 22 to multiswitch 20. It is noted that the LNBs 13 may also be from the same antenna (11A or 11B).

As shown in FIG. 1, ODU 10 provides satellite based services to a particular site 30 (usually some type of building, for example, a house, apartment or office building, etc.), which includes multiple IDUs. The multiswitch 20 is connected to a power source 31 and various IDUs 32A and 32B situated within site 30 by cables 24. In the illustrative example of FIG. 1, the signal received by antenna 11A is split and distributed by multiswitch 20 to IDUs 32A, while the signal received by antenna 11B is sent to IDU 32B. For example, IDUs 32A may comprise a set of receivers, while 32B may be a receiver connected to a PC for receiving Internet signals from a satellite based Internet service provider (ISP).

In the satellite communication system illustrated in FIG. 1, the satellite signals may already be encrypted when they are received by ODU 10 and sent to the IDUs 32A and 32B. Accordingly, IDUs 32A and 32B may comprise Integrated Receiver Decoders (IRDs), which include a processor for decrypting or descrambling the received signal. Further, IRDs may perform other functions, such as providing an electronic program guide (EPG) or recording certain programs on satellite TV signals.

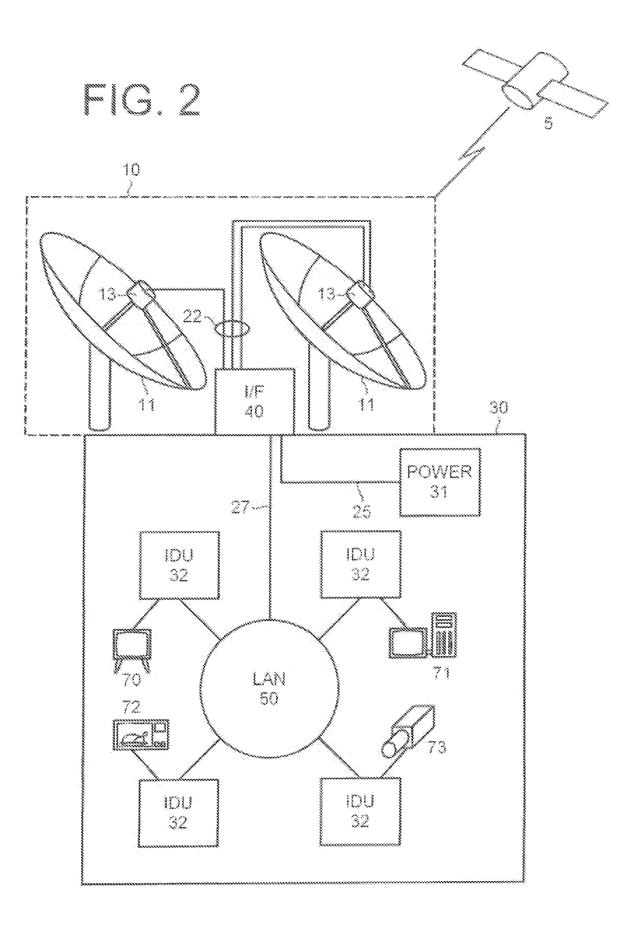

FIG. 2 illustrates an exemplary embodiment of the present invention where an interface device 40 connects the LNB 13 of an ODU 10 to multiple IDUs in conjunction with a wired LAN 50. The ODU 10 includes one or more satellite antennas 11, each of which includes one (or more) LNB 13. The LNB outputs are then connected via cables 22 to the interface device 40. Interface device 40 includes two output cables, including a power cable 25 connected to power source 31 within site 30, and a LAN connection 27 that is connected to LAN 50 running through site 30. The LAN 50 is connected to a plurality of IDUs 32. FIG. 2 as illustrated shows a dedicated cable 27 for the LAN connection. An existing cable, such as power cable 25, could also be used for the LAN connection.

The interface device 40 may be configured as part of the ODU 10, as shown in FIG. 2, and may even be integrated into a satellite antenna 11. Alternatively, the interface device 40 may be located apart from the ODU 10, either inside the building 30 (such as an attic) or at another outdoor location (such as on the roof). The interface device 40 may receive a single cable 22 from each LNB 13 at ODU 10. The interface device 40 may be connected to the ODU 10 via transmission cables (not shown). The transmission cables may allow the interface device 40 to send a signal to a satellite antenna 11, which is configured to transmit the signal to another site via satellite 5.

As shown in FIG. 2, each IDU 32 is associated with one or more satellite services. Such services may include satellite television 70, satellite based Internet service for a device 71, diagnostics/maintenance of appliances 72, and home security 73. Services such as appliance diagnostics/maintenance 72 and home security 73, may require data to be measured or collected at their corresponding IDUs 32 and transmitted back to a central processing location (not shown) for analysis. Conventional satellite communication systems (e.g., the system illustrated in FIG. 1) would require both a receiving and transmitting cable to connect these IDUs 32 to the multiswitch 20. However, by connecting the interface device 40 to each IDU 32 via LAN 50, the interface device 40 can both transmit and receive data from all of the IDUs 32 connected to a single data bus.

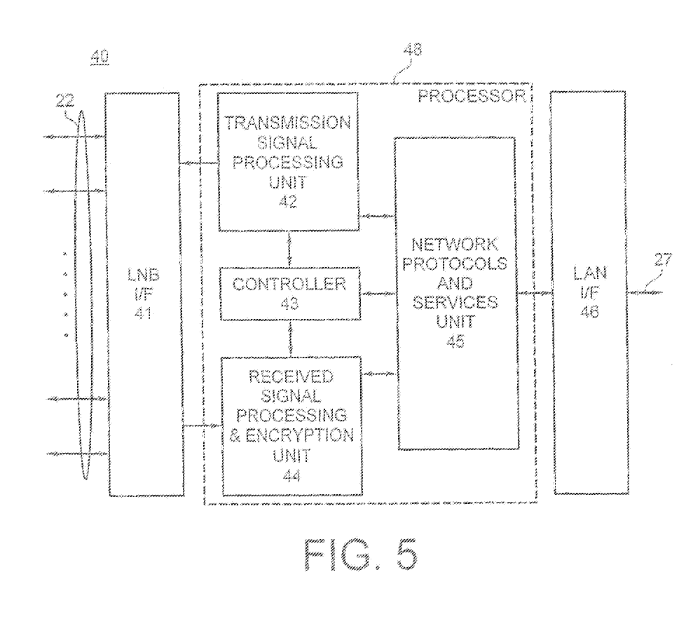

FIG. 5 is a block diagram of the interface device 40 according to the exemplary embodiment shown in FIG. 2. The LNBs 13 of an ODU 10 are connected via cables 22 to input/outputs ports on an LNB interface 41. The LNB interface 41 is connected to a received signal processing and encryption unit 44 and a transmission signal processing unit 42, which are both connected to a network protocols and services processing unit 45.

The elements of the LNB interface 41 may be conventional elements, such as a tuner/demodulator pair for processing an input from each cable 22. The tuner/demodulator pair processes an RF input from each cable 22 and produces a corresponding digital output. The digital outputs from each tuner/demodulator pair are multiplexed together and sent to the received signal processing and encryption unit 44. Similarly, the output from the transmission signal processing unit 42 is demultiplexed into plural inputs, sent to tuner/modulator pairs for conversion back into RF signals and sent out of cables 22.

Processing units 42, 44, and 45 are all connected to a controller 43. The network protocols and services processing unit 45 is connected to LAN interface 46. LAN cable 27 connects the LAN interface 46 to the wired LAN 50.

It should be noted that the transmission signal processing unit 42, received signal processing and encryption unit 44, network protocols and services unit 45, and controller 43 may comprise separate hardware units. Alternatively, a single processor 48 (designated by the dotted line in FIG. 5) may be configured to perform the functions of processing units 42-45. The interface device 40 may be configured as any combination of hardware and software units for performing the functions shown in FIG. 5.

Further, the interface device 40 shown in FIG. 5 merely illustrates an exemplary embodiment, and is in no way limited to including each functional block shown. For example, if a particular site 30 contains no IDUs 32 for transmitting data via satellite 5, then the interface device 40 need not include the transmission signal processing unit 42. Further, the interface device 40 may perform additional functions not shown in FIG. 5, as contemplated by those skilled in the art.

The operation of the interface device 40 will now be described in connection with FIGS. 2 and 5. Once the RF signal transmitted by a satellite 5 is received into a particular LNB 13, the signal may be sent to a corresponding input/output port of LNB interface 41. The RF signal may then be sent to the received signal processing and encryption unit 44, where the signal is converted into a digital baseband signal. The received signal processing and encryption unit 44 may perform other signal processing on the baseband signal, such as filtering noise and other unwanted information. In addition, the received signal processing and encryption unit 44 may encrypt the digital baseband signal, such that only IDUs having a certain decryption key will be able to decrypt the signal and access the information contained therein.

The processed digital signal may then be sent to the network protocols and services processing unit 45, which assembles the data into message packets, determines the destination address of each packet, and controls the transmission of such packets according to a set of network protocols. The specific software for running these network protocols may be stored to controller 43. The message packets are then transmitted to the LAN 50 through LAN interface 46 and LAN cable 27.

In an exemplary embodiment, the network protocols and services unit 45 may employ point-to-point communications to transmit packets of the baseband signal directly to the IDU 32 for which the signal is intended (e.g., signals are sent directly to the receiver at the site 30). The network protocols and services unit 45 may alternatively broadcast data packets to every IDU 32 in site 30. In this alternative embodiment, each IDU 32 may include a processor for examining the received packet and determining whether the data in the packet is intended for that IDU 32, or for another. Further, the network protocols and services processing unit 45 may be configured to choose between point-to-point or broadcast transmission of each baseband signal packet.

The network protocols and services unit 45 may also receive packets from the LAN 50, via LAN interface 46, which contain data to be transmitted to another site 30 over the satellite network. Accordingly, the network protocols and services unit 45 can reassemble the packets into the original digital baseband signal. The reassembled signal may be sent to transmission signal processing unit 42, where it is processed and converted back into an RF signal, suitable for transmission. The converted RF signal is then sent back to a transmitting antenna via LNB interface 41 and cable 22.

In an exemplary embodiment, the data being transmitted from an IDU 32 to the interface device 40 may be encrypted before transmission. Accordingly, the transmission signal processing unit 42 would then be capable of decrypting the base band signal reassembled by the network protocols and services unit 45, before converting the data into an RF signal.

As described above, controller 43 may be used to store the software needed for employing a particular set of network protocols. In addition, the controller 43 can be used as a buffer, especially when multiple satellite signals are being received by the interface device 40 at the same time. The buffer allows for units 42, 44, and 45 to process the received signals one at a time, perhaps according to a first-come, first-served basis or based on a priority assigned to each type of signal. Such assigned priorities may also be stored in a table in controller 43.

According to the embodiment illustrated in FIG. 2, the wired LAN 50 is preferably configured as a baseband network, such as Ethernet, token ring, ARCNET, USB, USB2, 1394 or FDDI. Such networks can be implemented by connecting the interface device 40 and each IDU 32 to a common data bus running through the site 30. This configuration avoids the need of installing a separate cable between a multiswitch 20 and each IDU 32 within the site. Therefore, multiple satellite services can be implemented in a particular site 30 without requiring multiple cables running throughout the site 30.

Further, a new IDU 32 can be easily installed at site 30 by merely connecting the IDU 32 to the data bus. In addition, unlike multiswitches 20, whether the interface device 40 has a free port for connecting to another IDU 32 is not an issue. Accordingly, the present invention is flexible for adding new satellite based services at a specific site 30.

In a further exemplary embodiment, the wired LAN 50 may employ the Transmission Control Protocol/Internet Protocol (TCP/IP) and include a connection to the Internet, for example, through high-speed leased lines or through a telephone wires connected to an Internet Service Provider (ISP). In such an embodiment, satellite based Internet service, such as DIRECPC®, may be provided to IDUs 32, which comprise receiver components connected to, or installed in, PCs or other processing devices. However, according to this embodiment, satellite Internet services are not limited to IDUs 32 connected to PCs. Such an IDU 32 may be connected to a television, personal digital assistant (PDA), or any other electronic device through which a user can access the Internet.

Some satellite Internet services are currently configured such that requests for digital content are transmitted from a subscriber's PC over a modem and telephone lines to an ISP and others are two-way satellite connections. In response to a request, the Internet server forwards the digital content to a location, where the digital content is uploaded to a satellite 5 and downloaded directly to the subscriber's PC. Such services provide very high-speed transmission of content from an Internet server to the PC. This embodiment may be particularly useful for applications requiring high data transmission rates, such as viewing streaming video, listening to streaming music or audio programs, etc.

By utilizing the wired LAN 50 of the present invention, a plurality of IDUs 32 (PCs) configured for satellite Internet service can receive content from the same satellite antenna 11 without requiring a plurality of cables running from the ODU 10 to the IDU. Further, each IDU 32 can transmit requests over the same cable connection, which connects the data bus of LAN 50 to the ISP.

Further, the present invention is in no way limited to satellite Internet services, where requests must be transmitted over a physical cable to the ISP. In another exemplary embodiment, requests for digital content may be transmitted from an IDU 32 over the LAN 50 to interface device 40, which forwards the request to an antenna 11 for transmission to a satellite 5. Accordingly, the satellite 5 may relay the request to a satellite antenna 11 of a satellite based ISP.

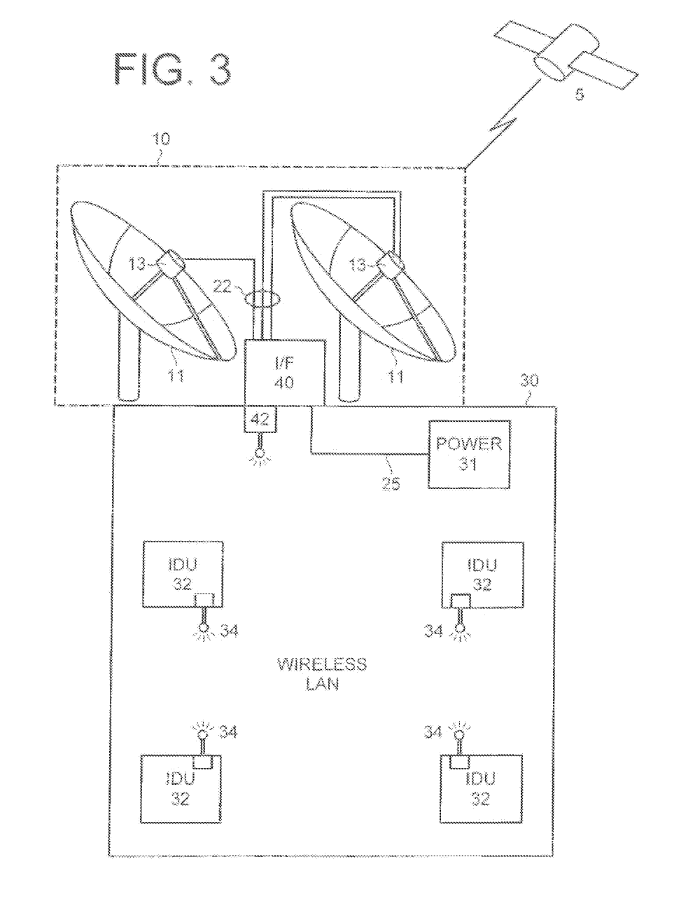

FIG. 3 illustrates another exemplary embodiment of the present invention where an interface device 40 uses a wireless LAN to connect the LNBs 13 of ODU 10 to multiple IDUs 32 of a particular site 30. The elements of ODU 10, as well as the connections between ODU 10 and the interface device 40, are similar to those shown in FIG. 2. Additionally, similar to the embodiment of FIG. 2, power cable 25 connects the interface device 40 to power source 31.

In FIG. 3, the interface device 40 includes an RF signal transmitter/receiver 42 for transmitting data to and/or for receiving data from each of the IDUs 32 over the wireless LAN. The RF transmitter/receiver 42 of the interface device 40 replaces the LAN cable 27 illustrated in FIGS. 2 and 5. Each of the IDUs 32 includes an RF signal transmitter/receiver 34 for receiving data transmitted by the interface device 40. if a particular IDU 32 does not require the capability of transmitting data over the satellite communication network, then the RF transmitter/receiver 34 for the IDU 32 may be operable only to receive RF signals.

In the exemplary embodiment of FIG. 3, the network protocols and services processing unit 45 of the interface device 40 may broadcast each baseband signal packet to all of the IDU transmitter/receivers 34. A processor within each IDU 32 can examine the received packets and determine whether or not the data was intended for the IDU 32. Alternatively, each IDU transmitter/receiver 34 can be configured to receive signals on different frequencies, and the interface device 40 can employ point-to-point communication by transmitting directly to an IDU 32 over the frequency corresponding to the IDU's transmitter/receiver 34.

In order to protect the privacy of the data packets being transmitted over the wireless LAN, the data packets may be encrypted before being transmitted from the interface device 40 to any of the IDUs 32, or vice versa. Each IDU 32 may therefore include an encryption/decryption key, for decrypting messages sent from the interface device 40 and for encrypting messages to be sent back to the interface device 40. Encrypting the data being transmitted over the wireless LAN can protect the data from being intercepted by neighbors, or anyone within close proximity of the site 30, who has a receiver.

The use of a wireless LAN as illustrated in FIG. 3 provides even greater flexibility for the satellite communication system of the present invention. This embodiment allows for new services, and accordingly, new IDUs 32 to be Installed at any location, without concern as to whether a connection to the LAN data bus is accessible from the location. The embodiment nuttier allows for portable, wireless IDUs 32 to be used within site 30.

In another exemplary embodiment of the present invention, a combination of a wired LAN and wireless LAN may be used to connect the interface device 40 to each of the IDUs 32 at a particular site 30. For example, a data bus may be used to connect multiple IDUs 32 together. The data bus may further be connected to an RF transmitter/receiver, which transmits and receives RF signals to and from an interface device 40 that includes a transmitter/receiver 42. In addition, other IDUs that include RF transmitters/receivers 34 may be installed in the site 30 to communicate with the interface device 40.

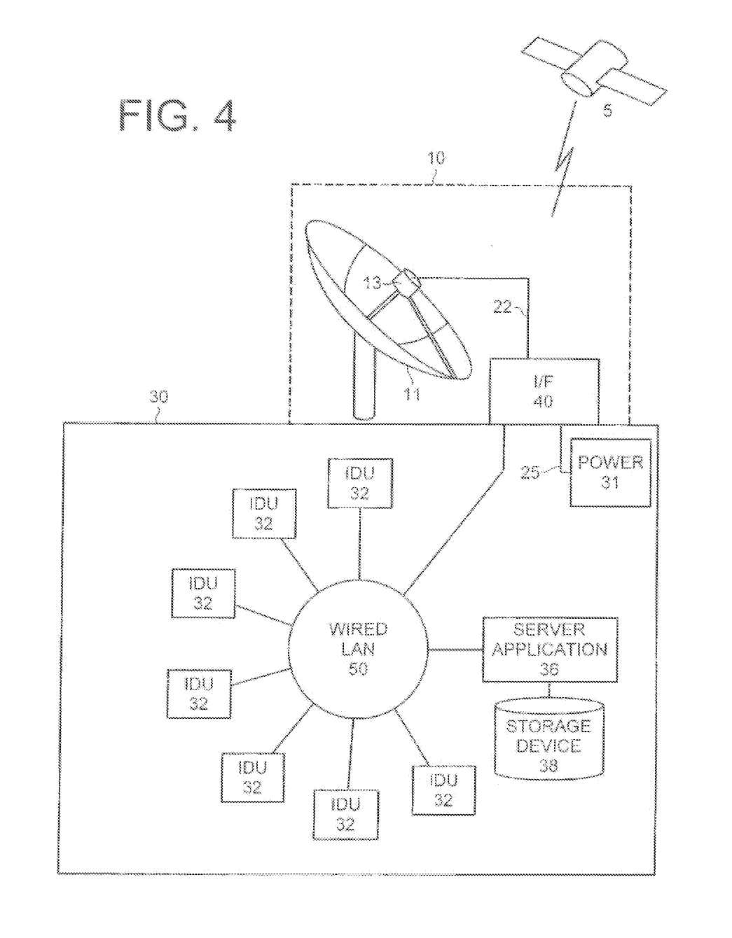

FIG. 4 illustrates an exemplary embodiment in which the present invention includes a server application to store and provide content on demand to a plurality of IDUs 32. The configuration of FIG. 4 is very similar to that of FIG. 2, the only difference being that a server application 36 and storage device 38 are connected to wired LAN 50 in site 30. However, it should be noted that this embodiment could also be implemented in the wireless LAN configuration shown in FIG. 3. It is further noted that the storage device 38 need not be part of the LAN 50, but merely accessible by the LAN 50. It is further noted that the server application 36 and/or the storage device 38 could be part of the interface 40.

The server application 36 may comprise a software application being run on any computer or processing device that includes data storage of adequate size. For example, the server application 36 may be executed on a processor 48 within an interface device 40, which has been modified to include the storage device 38.

According to this exemplary embodiment, a signal is transmitted via satellite 5 to the ODU 10, which sends the received signal to the interface device 40. The interface device 40 then sends the satellite data to the server application 36, which stores the data in storage device 38. Any of the IDUs 32 may send requests to the server application 36 over the wired LAN 50 for accessing the data stored in storage device 38. If the server application 38 accepts a request from an IDU 32, the data will be downloaded to the requesting IDU 32 over the LAN 50. In a further exemplary embodiment, the server application 36 may accept an IDU's request only after the user of the IDU 32 agrees to pay a fee for downloading the requested data.

The embodiment described above may be used to provide a video-on-demand (or other type of digital content on-demand service) to a plurality of consumers at a particular site 30. For instance, the site 30 may comprise an airplane, where each passenger seat includes a communication port connected to an installed wired LAN 50. In this embodiment, each passenger may be allowed to plug a network cable (e.g., Ethernet cable, twisted pair cable, etc.) into the port at his/her seat, and plug the other end of the cable into a laptop computer (which acts as an IDU). A satellite antenna 11 located on the airplane can be used to request and receive digital content (for example, movies, music, video games or other software applications) via satellite 5 from a content provider. This content provider may be a server maintained either by the airlines or by a commercial digital content providing service. A server application 36 within the airplane may store the received digital content in storage device 38, and any passenger can authorize the payment of a fee (using a credit card or some other form of electronic payment) to download the digital content from the server application 36 to the passenger's laptop computer. The passenger may then view, listen to, or play the digital content on his laptop during the flight. It is further noted that each of the teachings above with regard to a “movable MDU” could also be applicable to any of the standard, non-moving MDU embodiments described herein.

In such an application, a wide variety of movies, music, games, etc., may be pre-stored in storage device 38 of the server application 36. When the passenger makes a selection and authorizes payment, the chosen digital content may be downloaded from the server application 36 directly to the passenger's laptop computer.

Alternatively, the server application 36 may initially store only a menu of digital content choices that are available for the passengers. At such time that a passenger requests and pays for one of the digital content choices, the server application 36 may communicate a request via satellite antenna 11 to receive the selected piece digital content from the content provider. Once the selected digital content is received, the server application 36 will commence downloading of the content to the requesting laptop and store the digital content in the storage device 38. The next laptop computer requesting that particular piece of digital content when then be able to immediately download it from the server application 36. Whenever the storage space on storage device 38 becomes full, the server application 36 can choose to discard a stored piece of digital content based on the amount of time that has elapsed since the content was last requested (or by some other type of criteria). While this alternative does not limit the number of available digital content choices according to the storage capacity of storage device 38, it may cause passengers to wait longer for downloading a piece of digital content that has not yet been transmitted from the content provider to the server application 36. The digital content on-demand application described above is in no way limited to implementation on airplanes. The present invention can be used to provide digital content on-demand services in MDUs, cruise boats, trains, buses, or other sites 30 that cannot support a physical cable link to a digital content provider. Also, such an application may be implemented by the present invention at any site where a satellite link to a digital content provider would be more practical or provide better performance (e.g., transmission speed) than a cable link.

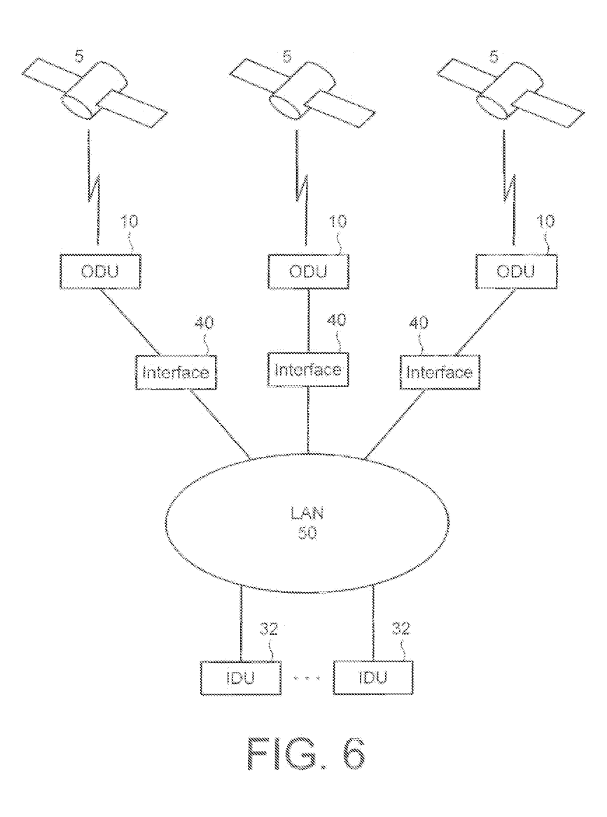

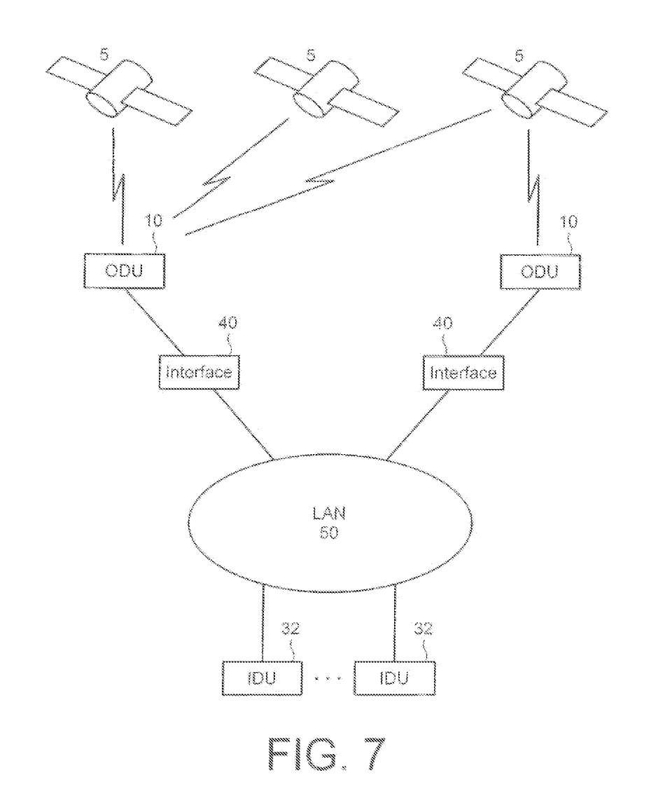

FIGS. 6 and 7 illustrate other preferred embodiments of the present invention. As illustrated, the relationship between satellites 5 and ODUs 10 may be varied. For example, in FIG. 6, each satellite 5 transmits to a specific ODU 10, whereas in FIG. 7, more than one satellite 5 is capable of transmitting to the same ODU 10. In a similar manner, one or more satellites 5 could transmit to the same ODU 10. The ODU 10 which is fed by multiple satellites 5 may be considered a “super” ODU. The embodiment of FIGS. 6 and 7 are directed to multiple ODU configurations with wired/wireless LAN 50 connectivity to multiple IDUs in cases where multiple ODUs are present, each capable of pointing at a different satellite 5.

The architecture between the ODUs 10, interfaces 40, LAN 50, and IDUs 32 of FIGS. 6 and 7 may be replaced with any one of the architectures described in other embodiments of the present invention. For example, the ODU 10 of FIG. 3 or FIG. 4 could be utilized in the embodiments illustrated in FIGS. 6 and 7. Similarly, the LAN 50 of FIGS. 2 or 3 could also be utilized as the LAN 50 in FIGS. 6 and 7.

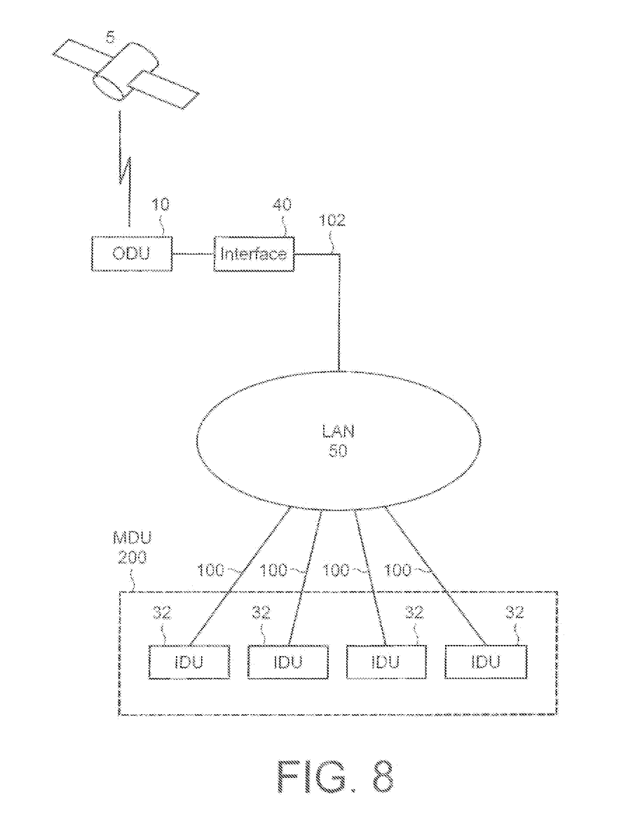

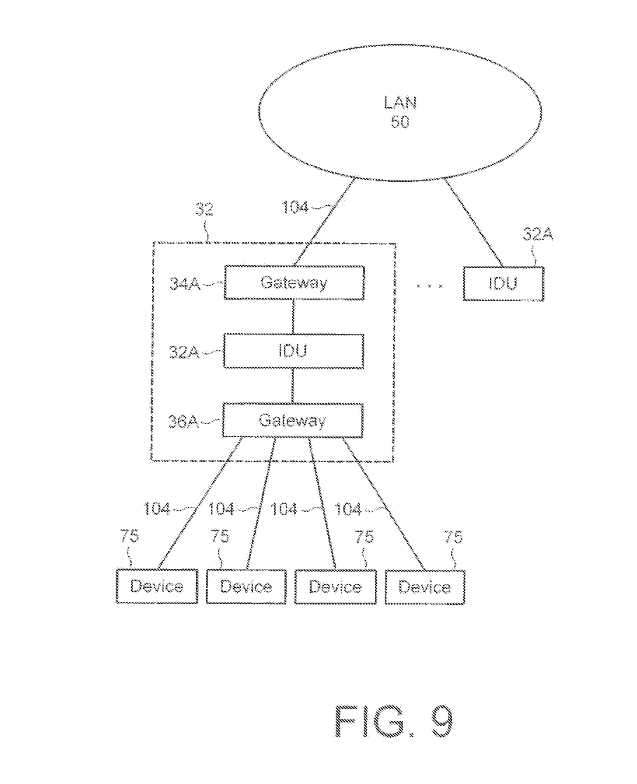

FIG. 8 illustrates yet another embodiment of the present invention, where interface 40 and/or LAN 50 may act as a converter. In particular, as illustrated in FIG. 8, although the original signal received by the ODU 10 is a satellite signal from satellite 5, the LAN 50 (as shown in FIG. 8) or the interface 40 may supply the information to IDUs 32 via a different connectivity. For example, connections 100 may be internet connections (either wired or wireless), DSL, cable modem, T1, phone line (either phone LAN, DSL, or cable), power line or other type of connection. Similarly, connection 102 could be any one of these other types of connections. It is noted that the LAN 50 may also be within the MDU 200, albeit possibly in a telco closet, or other suitable location.

FIG. 9 illustrates a variation on the embodiment of FIG. 8, wherein each IDU 32 includes a gateway 34A and/or a gateway 36A, which permits the IDU 32 to transmit to devices 75 and/or LAN 50 over any type of connection 104. As described above, connection 104 could be any of the previous types of connections.

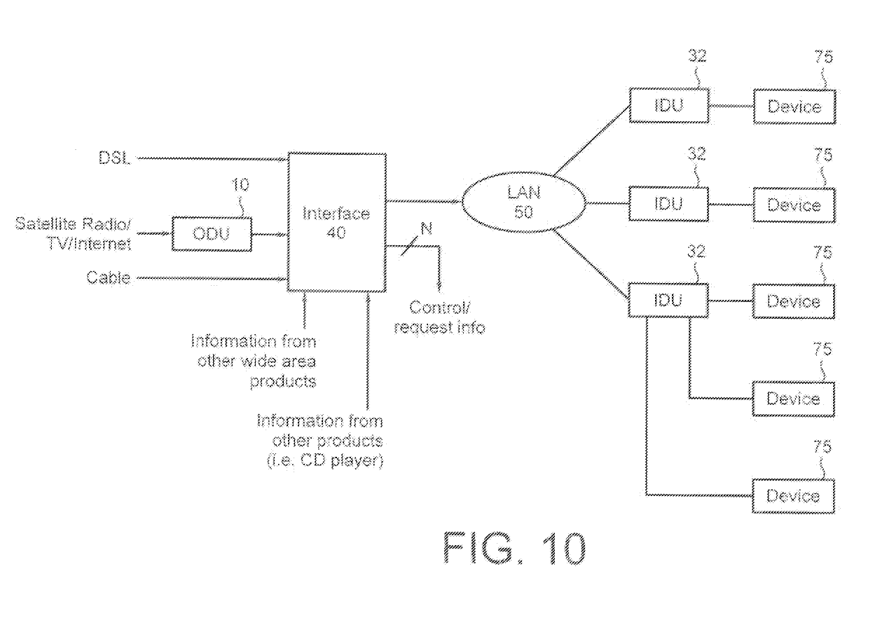

FIG. 10 illustrates yet another embodiment of the present invention, where the interface 40 acts as an converter and/or concentrator. As illustrated in FIG. 10, the interface 40 may receive information from, any number of connections, such as DSL, satellite, cable, among others. The interface 40 may also receive information from other wide area products and from other devices such as CD players. The interface 40 may convert/concentrate the received information for forwarding to LAN 50. Interface 40 may also include outgoing connections for sending control/request information to any of the information sources illustrated in FIG. 10.

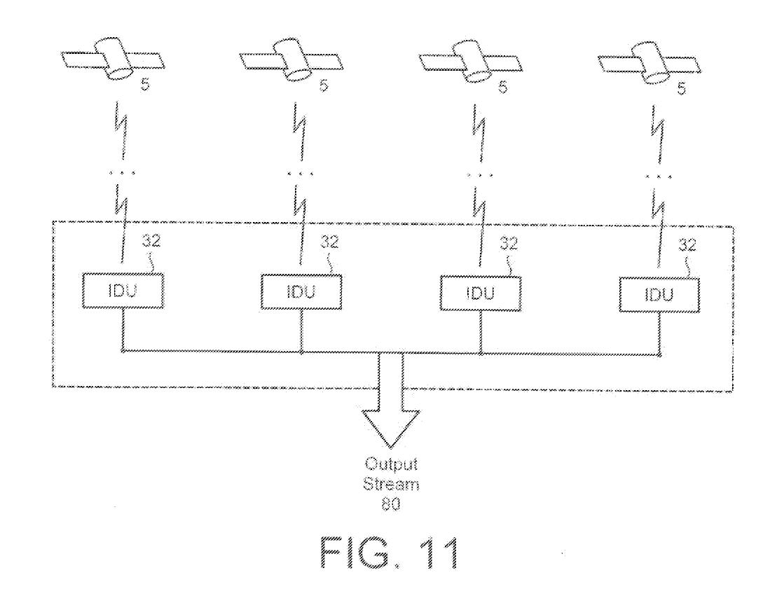

FIG. 11 illustrates yet another preferred embodiment of the present invention, where one or more IDUs 32 are chained together such that the throughput of one or more IDUs may be combined together and dynamically allocated to produce one or more output streams 80, larger than that which could be produced by any one IDU alone. The larger output stream 80 may be supplied to any number of devices 75 which require extra throughput.

It is noted that in a preferred embodiment, the ODU 10 is located outside on a building top and the interface device 40 is located inside relatively close to the ODU 10, for example in an attic or other storage space of the building. However, the interface device 40 could also be located outside as an integral part of the ODU 10. Further, the LAN 50 (wired or wireless) may be located near the interface device 40 or nearer to the IDUs 32. It is contemplated that the transmitter/receiver 42 could be an integral part of the ODU 10 or the interface device 40.

It is further noted that although the various embodiments of the present invention have been described in conjunction with satellite originated services, other services, including cable services are also contemplated as being within the scope of the present invention. It is further noted that one or more of the disclosed embodiments may be advantageously implemented in a multi-unit dwelling, such as an apartment building, condominium, cruise ship or other similar arrangement.

It is further noted that the IDUs 32 of the present invention may be connected to the wired or wireless LAN 50 via any number of technologies. These technologies include power line technology, phone line technology, standard internet technology (either wired or wireless, phone LAN, DSL, or cable). These technologies may be substituted, where appropriate, throughout the various embodiments of the present application as it would be known to one of ordinary skill in the art.

It is further noted that the wired LAN 50 may be configured with any type of wire arrangement, for example, a dedicated wire arrangement, such as a twisted pair or coaxial cable arrangement, or a non-dedicated arrangement, such as piggybacked on power, telephone, or other preexisting lines.

It is further noted that the types of data to be delivered are infinite, including, but not limited to, audio, video, streaming audio and/or video, voice, data, and/or voice over data and may provide a system of “always on” connectivity at every location serviced by the LAN 50.

It is further noted that the interface 40 may be used in place of or in addition to a cable modem DSL or other hardware that connects the input data feed of any kind to an IDU.

Further, although the IDUs have been illustrated as being separate entities from devices 70, 71, 72, 73, and 75, the IDU 32 could also be integrated into one or more of these devices 70, 71, 72, 73, and 75.

Still further, it is noted that one or more of the variations described above in conjunction with the exemplary embodiments of the present invention have been showed with respect to particular elements. However, one of ordinary skill of the art, when presented with the teachings outlined above, could apply these teachings to other elements of the present application.

For example, the wired LAN 50 and standalone IDUs of FIG. 2 could be used in any of the embodiments illustrated in FIGS. 1 and 3-11. Similarly, the wireless LAN 50 of FIG. 3 could be used in any of the embodiments illustrated in FIGS. 1-2 and 4-11. Likewise, server application 36 of FIG. 4 could be used in any of the embodiments illustrated in FIGS. 1-3 and 5-11.

The relationship between satellites and ODUs 10 of FIGS. 6 and 7 could also be used in any of the embodiments illustrated in FIGS. 1-5 and 8-11 and/or be applied to any other elements, such as ODU 10/interface 40, interface 40/LAN 50, LAN 50/IDU 32 and/or IDU 32/devices 70, 71, 72, 73, and 75. The conversion between LAN 50 and IDUs 32 of FIG. 8 and/or the conversion between IDU 32 and devices 70, 71, 72, 73, and 75 of FIG. 9 could also be used in any of the embodiments illustrated to FIGS. 1-7 and 10-11 and/or be applied to any other elements, such as ODU 10/interface 40, interface 40/LAN 50, LAN 50/IDU 32 and/or IDU 32/devices 70, 71, 72, 73, and 75.

The conversion and/or concentration functions performed by the interface 40 of FIG. 10 could also foe used in any of the embodiments illustrated in FIGS. 1-9 and 11 and/or be applied to any other elements, such as ODU 10, LAN 50, or IDU 32. Additionally, the dynamic allocation of IDU outputs into output stream 80 could also be used in any of the embodiments illustrated to FIGS. 1-10 and/or be applied to the input and/or output of any other elements, such as ODU 10, interface 40, or LAN 50.

the present invention being thus described, it will be obvious that the same may be varied in many ways. Such variations are not to be regarded as a departure from the spirit and scope of the invention, and all such modification as would be obvious to one skilled in the art are intended to be included within the scope of the following claims.

We claim:

1. A satellite communication system, comprising:
at least one satellite antenna for receiving a signal transmitted from a satellite, wherein said satellite antenna includes at least one Low Noise Block (LNB) converter;
an interface device including a connection to said LNB, and further including a connection to a local area network (LAN) connecting together a plurality of indoor units (IDUs), wherein said interface device converts said transmitted signal received from said LNB into a digital baseband signal to be transmitted across said LAN to at least one of the plurality of IDUs.
